(19) United States
(12) Patent Application Publication
(10) Pub. No.: US 2018/0134919 A1
(43) Pub. Date: May 17, 2018

(54) DUAL CURE STRUCTURAL ADHESIVE

(71) Applicant: GM GLOBAL TECHNOLOGY OPERATIONS LLC, Detroit, MI (US)

(72) Inventor: Bruce N. Greve, Clarkston, MI (US)

(21) Appl. No.: 15/447,288

(22) Filed: Mar. 2, 2017

Related U.S. Application Data
(60) Provisional application No. 62/420,823, filed on Nov. 11, 2016.

(51) Int. Cl. C09J 5/06; C09J 175/04; C09J 163/00; C09J 133/08; B32B 37/12; B32B 38/00; B32B 7/12

(52) U.S. Cl. CPC C09J 5/06; C09J 175/04; C09J 163/00; C09J 133/08; C09J 2475/00; B32B 38/0008; B32B 7/12; C09J 2433/00; C09J 2463/00; B32B 37/12

(57) ABSTRACT

Discloses herein is a structural adhesive that includes a curable resin composition, a photoinitiator and a thermal curing agent. The structural adhesive can be used to join two parts together.

### CROSS-REFERENCE TO RELATED APPLICATIONS

The present application claims priority to U.S. Provisional Application No. 62/420,823, filed on Nov. 11, 2016, the contents of which are incorporated by reference herein in their entirety.

### INTRODUCTION

The disclosure relates to structural adhesives.

Structural adhesives are used to bond metal and fiber reinforced composites to a variety of similar and dissimilar substrates. Structural adhesives find use in the manufacture of cars, trucks, boats and other products.

Structural adhesives are applied to the surface of a first part and, subsequently, a surface of a second part (of the same or different material) is positioned over the adhesive covered surface of the first part to form an adhesive joint. Since the parts often have uneven surfaces, it is desirable that the adhesive possess the ability to fill the resulting voids of varying depth. It is important that the adhesive remain uncured and fluid for a sufficient time to permit placing of the second part into contact with the adhesive.

When the first and second parts are made of metal, the adhesive joint may then be welded or riveted. The weld or rivet can cause a portion of adhesive to squeeze out of the joint. The joined parts are sent through a cleaning process. During the cleaning process excess adhesive that has squeezed out can be removed from the joint and deposited on another portion of the same item or on a subsequent item. The spurious deposition of adhesive increases processing steps and cost as it must be removed either before or after curing.

Accordingly, it is desirable to provide a structural adhesive which reduces or eliminates the spurious deposition of adhesive from a cleaning process.

### SUMMARY

In one exemplary embodiment, a structural adhesive comprises a curable resin composition, a photoinitiator and a thermal curing agent.

The curable resin composition may include polyurethane oligomers, epoxide oligomers, acrylate oligomers, or a combination thereof. More specifically, the curable resin composition may include acrylate terminated polyurethane oligomers, acrylate terminated epoxide oligomers, acrylate oligomers, or a combination thereof. The curable resin composition may further include a toughening agent.

In some embodiments, the photoinitiator includes an unsaturated acryloyloxy initiator.

In some embodiments, the thermal curing agent comprises dicyandiamide.

In another exemplary embodiment a method of adhering two parts comprises disposing a structural adhesive on a first part; disposing a second part on the structural adhesive located on the first part to form an article having an adhesive joint; exposing the adhesive joint of the article to actinic radiation; cleaning the article having an irradiated adhesive joint; and thermally curing the irradiated adhesive joint of the cleaned article. The first part and the second part may be metal. The irradiated adhesive joint may have a lap shear strength of at least 2 MPa as determined by ISO 4587.

In the method of adhering two parts, the curable resin composition may include polyurethane oligomers, epoxide oligomers, acrylate oligomers, or a combination thereof. More specifically, the the curable resin composition may include acrylate terminated polyurethane oligomers, acrylate terminated epoxide oligomers, acrylate oligomers, or a combination thereof. The curable resin composition may further include a toughening agent.

In the method of adhering two parts, the photoinitiator may include an unsaturated acryloyloxy initiator. The thermal curing agent may include dicyandiamide. The adhesive joint may b exposed to actinic radiation of 400 nm for 20 to 40 seconds.

In another exemplary embodiment an article comprises a first part joined to a second part by a cured structural adhesive which is the product of curing a structural adhesive using actinic radiation and thermal curing wherein the structural adhesive comprises a curable resin composition, a photoinitiator and a thermal curing agent. The first part and the second part may be metal. The curable resin composition may include polyurethane oligomers, epoxide oligomers, acrylate oligomers, or a combination thereof. More specifically, the curable resin composition may include acrylate terminated polyurethane oligomers, acrylate terminated epoxide oligomers, acrylate oligomers, or a combination thereof. The curable resin composition may further include a toughening agent.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a representation of an uncured adhesive joint between two parts;

FIG. 2 is a representation of washing the adhesive joint;

FIG. 3 is a representation of an adhesive joint being partially cured with actinic radiation; and

FIG. 4 is a representation of washing the partially cured adhesive joint.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment a structural adhesive comprises a resin composition, a photoinitiator and a thermal curing agent. A structural adhesive, as used herein, is defined as an adhesive capable of forming a metal to metal bond with a minimum lap shear strength of 16 MegaPascals as determined according to ISO 4587. The structural adhesive composition has two modes of curing, actinic radiation curing and thermal curing. Actinic radiation is defined as electromagnetic radiation such as visible light, UV light or X-rays, or corpuscular radiation such as electron beams. The structural adhesive is applied to a first part and the second part is disposed directly on the structural adhesive to form an article having an adhesive joint. In some embodiments the structural adhesive squeezes out from the adhesive joint. The first part may further be affixed to the second part by spot welding, riveting or the like. The affixed article is then exposed to actinic radiation. It is contemplated that the article having an adhesive joint can be exposed to actinic radiation and then the first part affixed to the second part by spot welding, riveting or the like. After radiation the part is washed and thermally cured. Without being bound by theory, it is suggested that the actinic radiation is sufficient to at least partially cure the surface of the adhesive, particularly any adhesive which has squeezed out from the joint, and stabilize the adhesive joint to the forces applied during washing. This reduces or eliminates the deposition of adhesive from the wash process in undesired locations.

The resin composition may comprise oligomers, monomers, or a combination thereof. Exemplary oligomers include polyurethane oligomers, epoxide oligomers, acrylate oligomers, or a combination thereof. At least a portion of the oligomers, monomers, or combination thereof comprise one or more functional groups that are capable of radical polymerization. Exemplary functional groups include an epoxy group and a terminal carbon double bond, particularly one which is adjacent to a carbonyl which is also adjacent to an electronegative hetero atom such as an oxygen or a nitrogen. Such a functional group can be formed by the reaction of acrylic acid with an epoxide oligomer or a polyurethane oligomer. Exemplary monomers include acrylates, styrene and other aryl alkenes, polyepoxides, and N-vinylpyrrolidone.

Polyurethane oligomers are formed by the reaction of at least one polyisocyanate and at least one monomeric or polymeric organic compound having two isocyanate reactive hydrogens, optionally in the presence of a catalyst. Exemplary polyisocyanates include aliphatic polyisocyanates, cycloaliphatic polyisocyanates, aromatic polyisocyanates, and combinations thereof. These polyisocyanates include alkyl and alkylene (alkene) polyisocyanates, cycloalkyl and cycloalkylene polyisocyanates, aryl and arylene polyisocyanates, and combinations thereof. More specifically, these isocyanates include toluene-2,4-diisocyanate, 4,4′-methylene-bis(cyclohexyl isocyanate), polymethylene polyphenylene isocyanate, 2,2,4-trimethylhexamethylene-1,6-diisocyanate, hexamethylene-1,6′diisocyanate, diphenylmethane-4,4′-diisocyanate, triphenyl-methane-4,4′,4″-triisocyanate, m-phenylene diisocyanate, p-phenylene diisocyanate, 2,6-toluene diisocyanate, 1,5-naphthalene diisocyanate, naphthalene-1,4-diisocyanate, diphenylene-4,4′-diisocyanate,3,3′-bi-toluene-4,4′-diisocyanate, 1,4-cyclohexylene dimethyl diisocyanate, xylene-1,4-diisocyanate, xylene-1,3-diisocyanate, cyclohexyl-1,4-diisocyanate, 3,3′-dimethyldiphenylmethane-4,4′-diisocyanate, isophorone diisocyanate, m-tetramethyl xylene diisocyanate, and combinations thereof. The monomeric or polymeric organic compound having two isocyanate reactive hydrogens can comprise, for example, a hydroxyl group, a primary amine group, a secondary amine group or a combination thereof. Exemplary polymeric compounds include polyether polyols, hydroxyl terminated polyalkylene esters of aliphatic, cycloaliphatic and aromatic diacids, cycloaliphatic and aromatic diacids, esters of polyhydric alcohols, and the like. Acrylate terminated polyurethanes can be made as described in U.S. Pat. No. 5,232,996.

Exemplary epoxy oligomers may have an average number of epoxy groups which is greater than or equal to 1, more specifically, greater than or equal to 2 or may be terminated by another functional group capable of radical polymerization such as an acrylate. The epoxy oligomers may be formed from epoxy compounds having at least two epoxy groups (polyepoxides). Exemplary epoxy compounds having at least two epoxy groups include polygycidyl ethers of polyhydric phenols such as ethylene glycol, triethylene glycol, 1,2-propylene glycol, 1,5-pentanediol, 1,2,6-hexanetriol, glycerol and 2,2-bis(4-hydroxy cyclohexyl propane, the polyglycidyl esters aliphatic or aromatic polycarbonxylic acids, such as oxalic acid, succinic acid, glutaric acid, terephthalic acid, 2,6-napthalene dicarboxylic acid and dimerized linoleic acid, the polyglycidyl ethers of pholhenols such as 2,2-bis(4-hydroxyphenyl) propane(bisphenol A), 1,1-bis(4-hydroxyphenyl) ethane, 1,1-bis(4-hydroxyphenyl) isobutene, 4,4′-dihydroxybenzophenone, 2,2-bis(4-hydroxyphenyl) butane, bis(2-dihydroxynapthyl) methane, phoroglucinol, bis(4-hydroxyphenyl) sulfone, 1,5-dihydroxynaphthalene, epoxy novolac, epoxy cresol, and combinations thereof. The epoxy oligomer may be acrylate terminated.

Acrylate oligomers can be obtained by the polymerization of one or more acrylic monomers, optionally in combination with a nonacrylic monomer. Exemplary acrylic monomers include methyl methacrylate; ethyl methacrylate; n-butyl methacrylate; isobutyl methacrylate; t-butyl methacrylate; hexyl methacrylate; ethyl-hexyl methacrylate, and combinations thereof. Exemplary acrylic oligomers include poly(methyl methacrylate/n-butylacrylate/ethyl acrylate), poly(n-butyl methacrylate/isobutyl methacrylate), poly(n-butyl methacrylate), poly(ethyl methacrylate), and combinations thereof.

The resin composition may further comprise a toughening agent. Toughening agents are polymers capable of increasing the toughness of a cured resin composition. The toughness can be measured by the peel strength of the cured compositions. Typical toughening agents include core/shell polymers, and butadiene-nitrile rubbers.

A core/shell polymer is understood to mean a graft polymer having a core comprising a graftable elastomer, which means an elastomer on which the shell can be grafted. The elastomer may have a glass transition temperature lower than 0° C. Typically the core comprises or consists of a polymer selected from the group consisting of a butadiene polymer or copolymer, an acrylonitrile polymer or copolymer, an acrylate polymer or copolymer or combinations thereof. The polymers or copolymers may be cross-linked or not cross-linked. Preferably, the core polymers are cross-linked.

On the core there is grafted one or more polymers; the “shell”. The shell polymer typically has a high glass transition temperature, i.e. a glass transition temperature greater than 26° C. The glass transition temperature may be determined by dynamic mechanical thermo analysis (DMTA) (“Polymer Chemistry, The Basic Concepts, Paul C. Hiemenz, Marcel Dekker 1984).

The “shell” polymer may be selected from the group consisting of a styrene polymer or copolymer, a methacrylate polymer or copolymer, an acrylonitrile polymer or copolymer, or combinations thereof. The thus created “shell” may be further functionalized with epoxy groups or acid groups. Functionalization of the “shell” may be achieved, for example, by copolymerization with glycidylmethacrylate or acrylic acid.

Typical core/shell polymers that may be used are core/shell polymers comprising a polyacrylate shell, such as for example a polymethylmethacrylate shell. The polyacrylate shell, such as the polymethylmethacrylate shell may not be cross-linked.

Typically, the core/shell polymer that may be used comprises or consists of a butadiene polymer core or a butadiene copolymer core, such as for example a butadiene-styrene copolymer core. The butadiene or butadiene copolymer core such as the butadiene-styrene core may be cross-linked.

The core/shell polymer may have a particle size from about 10 to 1,000 nm, preferably from 150 to 500 nm.

Suitable core/shell polymers and their preparation are for example described in U.S. Pat. No. 4,778,851. Core/shell polymers are commercially available.

The photoinitiator is a curing agent which forms at least one radical upon exposure to actinic radiation. Exemplary photoinitiators include a hydrogen acceptor such as an aliphatic amine in combination with a radical generator such as a benzophenone, a xanthone, or a quinone, benzyl dimethyl acetal, benzoin ether, acetophenone, benzoyl oxime, acyl phosphine, onium salts (typically iodonium or sulfonium salts), and organometallic compounds such as ferrocinium, and pyridinium. Additional exemplary photoinitiators include unsaturated acryloyloxy compounds such as 2-hydroxy-1-[4-(2-acryloyloxyethoxy)phenyl]-2-methyl-1-propanone.

Useful thermal curing agents form bonds between oligomers, monomers or a combination thereof at temperature above room temperature. They include both radical initiators and crosslinking compounds. Exemplary thermal curing agents include peroxides, azo compounds, primary amines, secondary amines, imidazole derivatives, N,N-dialkylurea derivatives, N,N-dialkylthioruea derivatives, acid anhydrides, trifluoroboron complex compounds, or a combination thereof. The amines may be aliphatic, cycloaliphatic, aromatic, or aromatic structures having one or more amino moiety. Examples of thermal curing agents include dicyandiamide, 4,4′-diaminodiphenylsulfone, 2-n-heptadecylimidazole, isophthalic acid dihydrazide, tetrahudrophthalic anhudride, isophoronediamine, m-phenylenediamine, N-aminoethylpiperazine, melamine, guanamine, trisdimethylphenol, and combinations thereof.

The thermal curing agent may be a polyether amine having one or more amine moieties, including those polyether amines that can be derived from polypropylene oxide or polyethylene oxide.

The thermal curing agent may also comprise a redox initiator in which a peroxide is combined with metal or metal compound.

The structural adhesive may further comprise adjuvants such adhesion promoters, corrosion inhibitors, rheology controlling agents, reactive diluents, pigments, fillers, and combinations thereof.

Reactive diluents may be added to control the flow characteristics of the adhesive composition. Suitable diluents can have at least one reactive terminal end portion and, preferably, a saturated or unsaturated cyclic backbone. Preferred reactive terminal ether portions include glycidyl ether. Examples of suitable diluents include the diglycidyl ether of resorcinol, diglycidyl ether of cyclohexane dimethanol, diglycidyl ether of neopentyl glycol, triglycidyl ether of trimethylolpropane.

Fillers may include silica-gels, Ca-silicates, phosphates, molybdates, fumed silica, clays such as bentonite or wollastonite, organo-clays, aluminium-trihydrates, hollow-glass-microspheres; hollow-polymeric microspheres and calcium-carbonate.

Pigments may include inorganic or organic pigments including ferric oxide, brick dust, carbon black, titanium oxide and the like.

Actinic Curing: In some embodiments, the composition may reach a lap shear strength of at least 2 MPa after actinic curing. Since the lap shear strength can still increase when curing the composition at the same conditions for longer periods, this kind of curing is referred to as partial curing. Typically, a lap shear strength of at least 4 MPa can be achieved by curing the composition at a wave length of 400 nanometers (nm) for 20 to 40 seconds. The composition may have lap shear strength at least 5 MPa after curing at a wave length of 400 nm for 30 to 60 seconds, or at least 7 MPa after curing at a wave length of 400 nm for 40 to 300 seconds. Lap shear strength is determined according to ISO 4587.

Thermal curing: Complete curing is achieved when the lap shear strength no longer increases when continuing thermal-curing of the article at the same conditions. Complete curing can be achieved by heating the article at the appropriate temperature for the appropriate length of time. Full (complete) cure is typically brought about by heating the article to a temperature of 80 to 220° C. Typically the heating is carried out for at least 15 minutes at 160° C.

The structural adhesive may be used to supplement or completely eliminate a weld or mechanical fastener by applying the adhesive composition between two parts to be joined and curing the adhesive to form a bonded joint. At least one of these parts or both parts may be of metal such as steel, iron, copper, aluminum etc. including alloys thereof, or a carbon fiber, a glass fiber or glass or a plastic such as, for example, polyethylene, polypropylene, polycarbonate, polyester, polyamide, polyimide, polyacrylate, or polyoxymethylene or mixtures thereof. In some embodiments both parts are metal. In areas of adhesive bonding, the adhesive can be applied as liquid, paste, and semi-solid or solid that can be liquefied upon heating, or the adhesive may be applied as a spray. It can be applied as a continuous bead, in intermediate dots, stripes, diagonals or any other geometrical form that will conform to forming a useful bond. Preferably, the adhesive composition is in a liquid or paste form. The adhesive placement options may be augmented by welding or mechanical fastening.

The welding can occur as spot welds, as continuous seam welds, or as any other attachment technology such as riveting that can cooperate with the adhesive composition to form a mechanically sound joint. In particular, it may be used as structural adhesive in vehicle assembly, such as the assembly of watercraft vehicles, aircraft vehicles or motorcraft vehicles, such as cars, motor bikes or bicycles. In particular the structural adhesive may be used as hem-flange adhesive. The adhesive may also be used in body frame construction. The structural adhesives may also be used in architecture or as structural adhesive in household and industrial appliances.

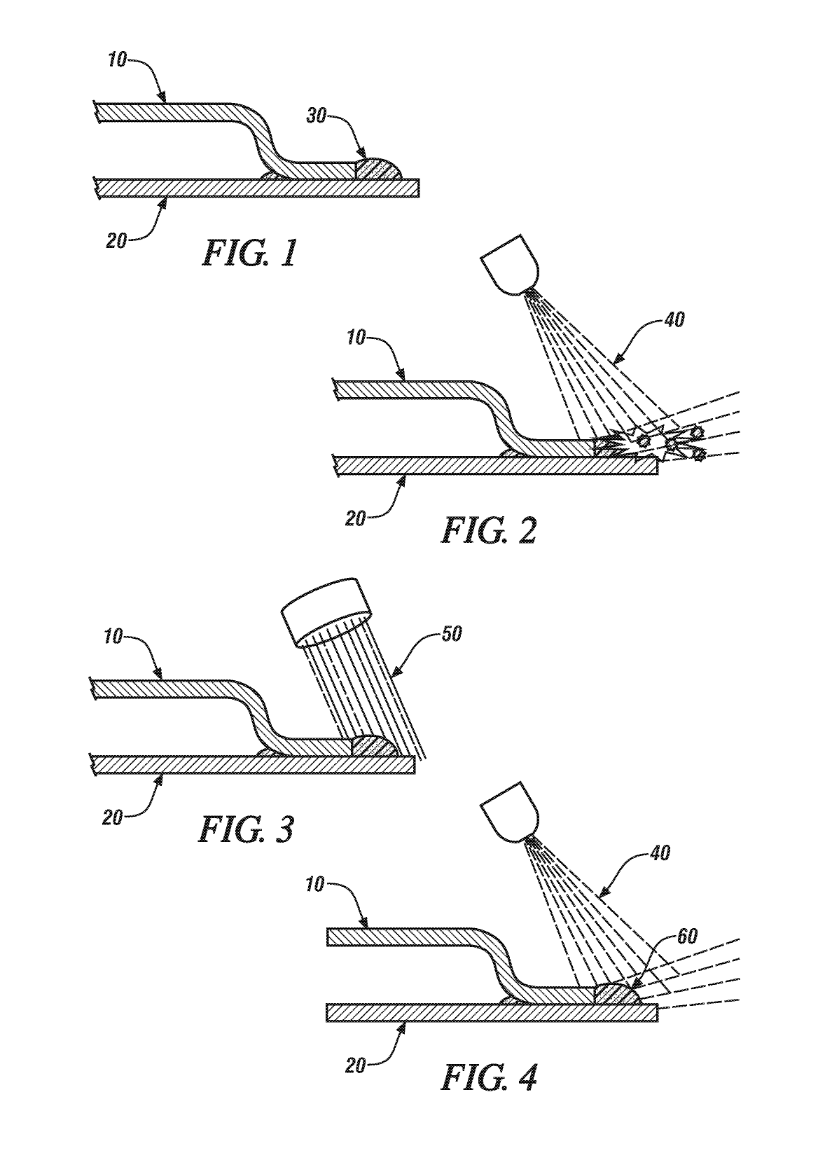

Turning now to the Figures, FIG. 1 shows an adhesive joint between two metal panels, 10 and 20 in which structural adhesive without actinic radiation has been squeezed out, 30. FIG. 2 shows the adhesive joint of FIG. 1 being cleaned, 40. As shown in FIG. 2 the cleaning can remove portions of the structural adhesive. These portions can be deposited in undesired locations. FIG. 3 shows the squeezed out adhesive 30 being subjected to radiation, 50. FIG. 4 shows the irradiated adhesive 60 being cleaned and no portions are removed. It is contemplated that cleaning, 40, removes less than 3 volume % (vol %) of the irradiated adhesive, wherein volume percent (vol %) is based on the total quantity of applied structural adhesive.

Cleaning may comprise subjecting the adhesive joint to a pressurized spray, dipping the adhesive joint into a cleaning solution, or a combination thereof. The pressurized spray can have a pressure of 10 to 50 pounds per square inch (psi), or, 20 to 40 psi, or 25 to 35 psi. The pressurized spray can comprise water, deionized water, or a cleaning solution such as an alkali cleaning solution or phosphate solution. Similarly, the adhesive joint may be dipped into a cleaning solution comprising water, deionized water, or a cleaning solution such as an alkali cleaning solution or phosphate solution.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A structural adhesive comprising a curable resin composition, a photoinitiator and a thermal curing agent.

2. The structural adhesive of claim 1, wherein the curable resin composition comprises polyurethane oligomers, epoxide oligomers, acrylate oligomers, or a combination thereof.

3. The structural adhesive of claim 2, wherein the curable resin composition comprises acrylate terminated polyurethane oligomers, acrylate terminated epoxide oligomers, acrylate oligomers, or a combination thereof.

4. The structural adhesive of claim 1, wherein the curable resin composition further comprises a toughening agent.

5. The structural adhesive of claim 1, wherein the photoinitiator comprises an unsaturated acryloyloxy initiator.

6. The structural adhesive of claim 1, wherein the thermal curing agent comprises dicyandiamide.

7. A method of adhering two parts comprising disposing a structural adhesive on a first part; disposing a second part on the structural adhesive located on the first part to form an article having an adhesive joint; exposing the adhesive joint of the article to actinic radiation; cleaning the article having an irradiated adhesive joint; and thermally curing the irradiated adhesive joint of the cleaned article, wherein the structural adhesive comprises a curable resin composition, a photoinitiator and a thermal curing agent.

8. The method of claim 7, wherein the first part and the second part are metal.

9. The method of claim 7, wherein the irradiated adhesive joint has a lap shear strength of at least 2 MPa as determined by ISO 4587.

10. The method of claim 7, wherein the curable resin composition comprises polyurethane oligomers, epoxide oligomers, acrylate oligomers, or a combination thereof.

11. The method of claim 10, wherein the curable resin composition comprises acrylate terminated polyurethane oligomers, acrylate terminated epoxide oligomers, acrylate oligomers, or a combination thereof.

12. The method of claim 7, wherein the curable resin composition further comprises a toughening agent.

13. The method of claim 7, wherein the photoinitiator comprises an unsaturated acryloyloxy initiator.

14. The method of claim 7, wherein the thermal curing agent comprises dicyandiamide.

15. The method of claim 7, wherein the adhesive joint is exposed to actinic radiation of 400 nm for 20 to 40 seconds.

16. An article comprising a first part joined to a second part by a cured structural adhesive which is the product of curing a structural adhesive using actinic radiation and thermal curing wherein the structural adhesive comprises a curable resin composition, a photoinitiator and a thermal curing agent.

17. The article of claim 16 wherein the first part and the second part are metal.

18. The article of claim 16 wherein the curable resin composition comprises polyurethane oligomers, epoxide oligomers, acrylate oligomers, or a combination thereof.

19. The article of claim 18, wherein the curable resin composition comprises acrylate terminated polyurethane oligomers, acrylate terminated epoxide oligomers, acrylate oligomers, or a combination thereof.

20. The article of claim 19, wherein the curable resin composition further comprises a toughening agent.
